(19) United States
(12) Patent Application Publication
(10) Pub. No.: US 2014/0231057 A1
(43) Pub. Date: Aug. 21, 2014

(54) Heat exchanger incorporating integral flow directors

(71) Applicant: VACUUM PROCESS ENGINEERING, INC., Sacramento, CA (US)

(72) Inventor: Carl Schalansky, Sacramento, CA (US)

(73) Assignee: VACUUM PROCESS ENGINEERING, INC., Sacramento, CA (US)

(21) Appl. No.: 13/772,563

(22) Filed: Feb. 21, 2013

(51) Int. Cl. F28F 3/04; B23P 15/26

(52) U.S. Cl. CPC F28F 3/048; B23P 15/26
USPC 165/169; 29/890.052

(57) ABSTRACT

The present invention describes a heat exchanger and method of making the heat exchanger having flow directors for directing the flow of fluids to one or more portions of the heat exchanger. The heat exchanger comprises a main body adapted for heat exchange having a plurality of channels adapted to receive fluid flow. The heat exchanger also includes a plurality of heat exchanging elements which provide exchange of heat as fluid flows therein and defines one or more fluid flow channels. At least one flow director is adapted for directing fluid flow from an external source to the fluid flow channels, whereby hydraulic efficiency is maximized by preventing fluid turbulence associated with non-directed flow of fluid within.

### FIELD OF THE INVENTION

The present invention is directed to the field of heat exchangers; and more particularly to heat exchangers having flow directors for directing the flow of fluids to one or more portions of the heat exchanger.

### BACKGROUND OF THE INVENTION

Often, an operating machine, electronic component or other system generates waste heat in the course of its normal operation. If this waste heat is not removed, degraded performance or damage to the system may result. Frequently, the operating temperature of a system needs to be precisely maintained in order to obtain optimal performance. For example, it is often desirable to cool the sensors used in thermal imaging cameras to improve the sensitivity of the imager. Further, analytical instruments may require that the sample to be analyzed be presented to the instrument at a precisely controlled temperature.

Heat exchangers permit heat to be removed from or added to the sample as may be desired. A common type of heat exchanger is referred to as a “heat sink.” A heat sink typically transfers heat between a solid object and some fluid media, which may be a liquid, air or other gas. Computer microprocessors frequently employ heat sinks to draw heat from the processor to the surrounding air, thereby cooling the microprocessor. Such a heat sink could also comprise a closed fluid system. For example, a recirculating liquid coolant might be used to transfer heat from that portion of the heat sink in contact with the heat-generating device to a remotely located radiator. Regardless of the type of heat exchanger, it is desirable to obtain a high degree of heat transfer efficiency.

Fluid flow should be efficient with minimal pressure loss and with fluid dynamics that promote efficient heat transfer. Additionally, other important criteria are known and will not be detailed here. Typically a heat exchanger comprises a heat exchanging element and some means of controlling the flow of the heat-exchanging medium. Frequently this medium is a gas or liquid. Flow channels may be provided to control fluid flow and promote efficient heat transfer between the heat exchanging element and the heat exchanging fluid. Particularly in the case of liquid mediums, an inlet and an outlet manifold is often provided so that the liquid may be readily coupled via a hose or pipe that may be connected to a recirculating pump or other pressure source.

An example of this type of heat exchanger is that of an automobile radiator. Inside the radiator is a plurality of water cooling channels coupled to heat conducting fins. Air is forced across the fins to cool the water inside. The water is then circulated throughout the engine block to cool the engine. A typical automobile radiator comprises a vertical water inlet tube that services a plurality of horizontal cooling channels. Similarly, a vertical water outlet tube collects water from these channels. The inlet and outlet tubes are typically at right angles to the cooling channels. Usually hydraulic pressure is relied on to force the water to make the 90 degree angle change as it flows from the inlet tube and into the cooling tubes, and again as it flows from the cooling tubes into the outlet tube. While this method of flow re-direction is inefficient, it constitutes a relatively minor energy drain with respect to powering the automobile. However, as energy costs escalate and products become ever more competitive, such inefficiencies are no longer acceptable.

The heat exchanger and the method of making the heat exchanger of the present invention overcome many of the shortcomings of previous designs, particularly with respect to hydraulic efficiency, the transition of fluid flow between the inlet and outlet manifolds, and the heat exchanger proper.

### SUMMARY OF THE INVENTION

The present invention describes a heat exchanger and method of making the heat exchanger, having flow directors for directing the flow of fluids to one or more portions of the heat exchanger. In an illustrative embodiment, the heat exchanger having flow directors comprises a main body adapted for heat exchange having a plurality of channels adapted to receive fluid flow. The main body has a first wall and a back wall sized and shaped to contain fluid flow therein. The heat exchanger also includes a plurality of heat exchanging elements positioned between the front wall and the back wall to form at least one fluid flow channel. Each of the heat exchanging elements has a length that traverses the length of the main body. At least one flow director is adapted for directing fluid flow, and at least one fluid manifold is adapted for receiving fluid from an external source. Fluid from an external source is directed to the fluid flow channels whereby hydraulic efficiency is maximized, i.e. reducing pressure drop, by preventing fluid turbulence associated with non-directed flow of fluid within.

A significant advantage of the present invention is the ability to readily create integral flow directors in a heat exchanger. Moreover, the flow directors may take on a variety of shapes and curvatures as may be desired to promote efficient fluid direction change in a heat exchanger. A further advantage of the instant invention is that the flow directors may be formed without the use of additional parts, or without the requirement for additional processing steps. The heat exchanging device with flow directors may also be formed by a highly scalable process, thereby permitting heat exchangers of any size to be produced.

Accordingly, it is an objective of the present invention to provide a heat exchanging device that reduces the amount of turbulence in the inlet and/or outlet manifold associated with fluid flow therein.

It is a further objective of the present invention to provide a heat exchanging device that increases hydraulic efficiency and the transition of fluid flow between the inlet and outlet manifolds and the heat exchanger proper.

It is yet another objective of the present invention to provide a heat exchanging device having integral flow directors.

It is a still further objective of the present invention to provide a heat exchanging device having integral flow directors adapted to direct fluid flow to one or more heat exchanging channels, thereby providing a more even flow distribution between heat exchanger elements.

It is a further objective of the present invention to teach a process whereby heat exchangers incorporating integral flow directors may be simply and economically produced.

It is yet another objective of the present invention to teach a process that provides a heat exchanging device having integral flow directors which is readily adaptable to modern manufacturing processes.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a front perspective view of an illustrative example of a heat exchanging device with flow directors in accordance with the present invention;

FIG. 2 is a back perspective view of the heat exchanging device with flow directors in accordance with the present invention;

FIG. 3 is a perspective view of the heat exchanging device with flow directors with inlet and outlet manifolds;

FIG. 4A illustrates a heat exchanging device with flow directors in accordance with the present invention with the upper wall removed to show the arrangement of the internal components;

FIG. 4B illustrates the flow of fluid within the heat exchanging device with flow directors shown in FIG. 4A;

FIG. 4C is an exploded view of the flow directors formed from a series of multiple stacked laminar plates to form a particular three dimensional shape;

FIG. 5A is a perspective view of an illustrative example of a flow director;

FIG. 5B is a perspective view of an alternative embodiment of a flow director;

FIG. 5C is a perspective view of an alternative embodiment of a flow director;

FIG. 5D is a perspective view of an alternative embodiment of a flow director;

FIG. 5E is a perspective view of an alternative embodiment of a flow director having a generally “C” shape;

FIG. 6A is a perspective view of a first manifold laminar plate of an inlet manifold;

FIG. 6B is a perspective view of a second manifold laminar plate of an inlet manifold;

FIG. 6C is a perspective view of a third manifold laminar plate of an inlet manifold;

FIG. 6D is a perspective view of a fourth manifold laminar plate of an inlet manifold;

FIG. 6E is a perspective view of a fifth manifold laminar plate of an inlet manifold;

FIG. 7 is a front perspective view of an alternative embodiment of a heat exchanging device with flow directors in accordance with the present invention;

FIG. 8A illustrates the heat exchanging device with flow directors shown in FIG. 7 with the upper wall removed to show the arrangement of the internal components;

FIG. 8B illustrates the flow of fluid within the heat exchanging device with flow directors shown in FIG. 8A;

FIG. 9 is a perspective view of the heat exchanging device with flow directors shown in FIG. 7 after the extrusion process, illustrating the initial step of forming finger like flow directors;

FIG. 10 is a front view of the heat exchanging device with flow directors shown in FIG. 9;

FIG. 11 is a perspective view of the heat exchanging device with flow directors shown in FIG. 9, illustrating removal of a portion of the heat exchanging main body.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

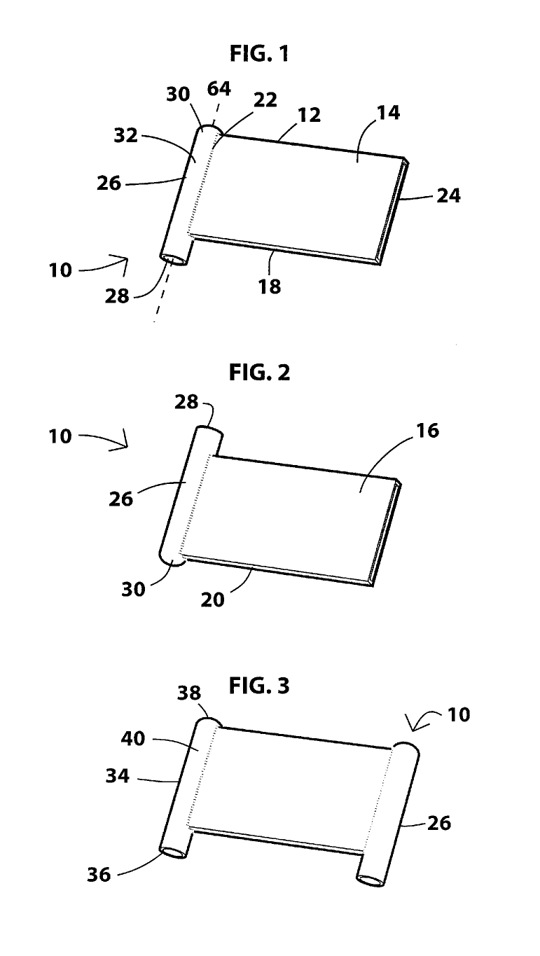

Referring to FIG. 1, a perspective view of an illustrative embodiment of a heat exchanging device with flow directors, referred to generally as 10, is illustrated. The heat exchanging device with flow directors 10 contains a main body 12, preferably made of a laminar material and/or other materials that exchange heat such as metals, including aluminum copper, nickel, brass or stainless steel, ceramics, plastics, glass, or other suitable materials which act as a heat exchanging element. The main body 12 may be formed by an extrusion process, though other methods known to one of skill in the art may also be employed. The main body 12 is defined by a top wall 14, a bottom wall 16, two side walls 18 and 20, a first end 22, and a second end 24. The distance between the first end 22 and the second end 24 defines the length of the heat exchanging device with flow directors 10.

As shown in FIGS. 1 and 2, the first end 22 contains a substantially cylindrically shaped first manifold, an inlet manifold 26, integrally formed or attached thereto. The inlet manifold 26 contains a first open end 28 sized and shaped to allow fluid from an external source, such as a liquid or a gas, to enter therein, a second closed end 30, and a manifold body 32 there between. The second end 24 of the heat exchanging device with flow directors 10 may be open to allow fluid that has entered into and flowed within the main body 12 to exit. The inlet manifold 26 is provided to facilitate coupling of fluid inlet lines, such as hoses, tubes or pipes, or other conduits to the heat exchanger. While the inlet manifold 26 is shown having a generally cylindrical shape, any shape may be used.

The heat exchanging device with flow directors 10 may also contain a second manifold, an outlet manifold 34, integrally formed or attached to the second end 24, see FIG. 3. The outlet manifold 34 as shown includes a first open end 36 which is sized and shaped to allow fluids, such as a liquid or a gas, to exit the main body 12, a second end 38 which is closed, and an outlet manifold body 40. While the outlet manifold 34 is shown having the first end 36 being open, it is within the scope of this invention that the second end 38, or both ends 36 and 38 contain an opening for exiting fluid flow. The outlet manifold 34 is provided to facilitate coupling of outlet lines, such as hoses, tubes or pipes, or other conduits from the heat exchanger. While the outlet manifold 34 is shown having a generally cylindrical shape, other shapes may be used.

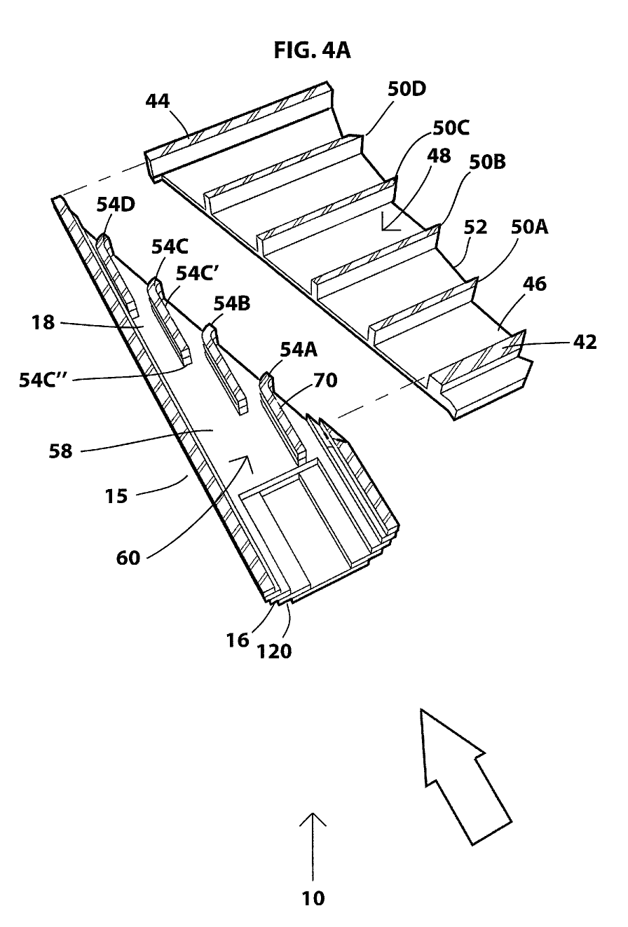

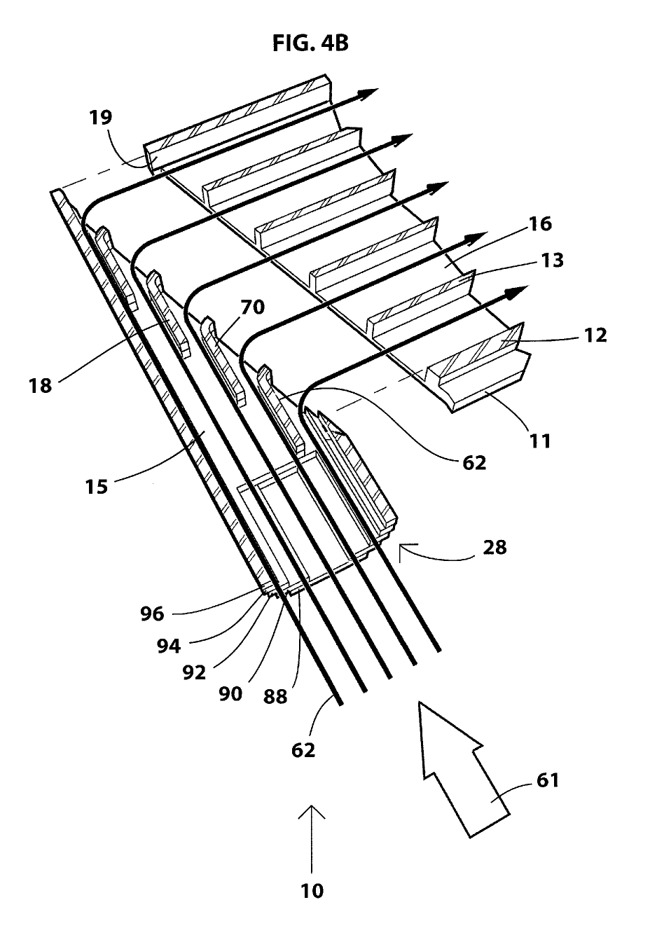

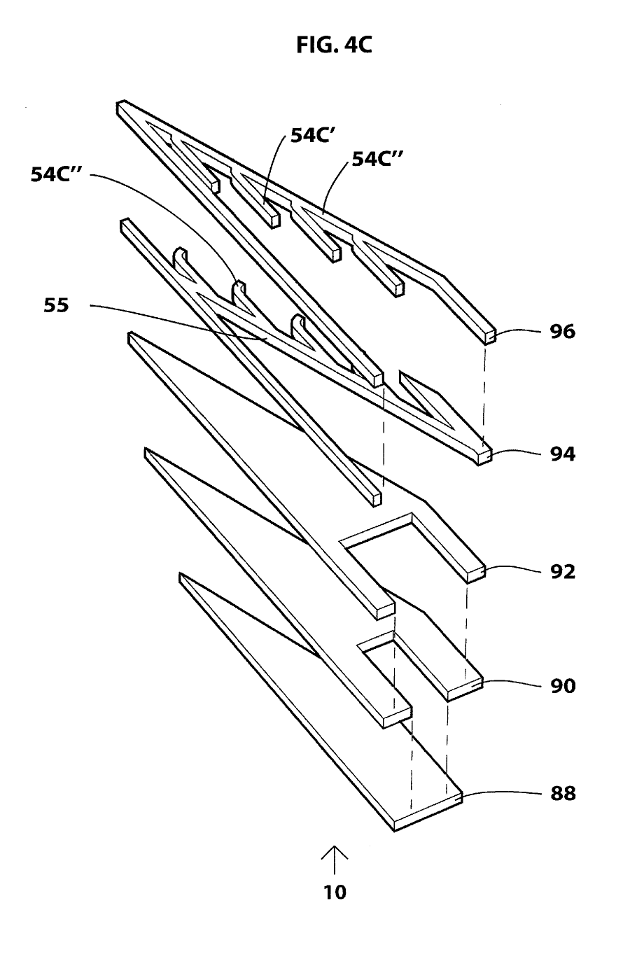

Referring to FIG. 4A, an illustrative embodiment of the heat exchanging device with flow directors 10 is shown. The upper wall 14 has been removed in order to illustrate the inner components and arrangement thereof. In addition, the outlet manifold 34 has been removed. The main body 12 is adapted to provide fluid containment by having a first proximal wall 42 and a second distal wall 44. Both the first proximal wall 42 and the second distal wall 44 traverse the length of the heat exchanging device with flow directors 10, and have a height which extends from the inner surface 46 of the bottom wall 16 to the inner surface of the top wall 14 (not illustrated). The first proximal wall 42 and the second distal wall 44 function to contain and confine a heat exchanging fluid, such as a liquid or a gas, to the interior 48 of the heat exchanging device with flow directors 10.

Placed within the interior 48 are one or more heat exchanging elements, illustrated as heat exchanging fins 50A-50D, collectively referred to as fins 50. The fins 50 are preferably made of metal having heat conductive properties such as aluminum or copper. The fins 50 are arranged in a substantially parallel manner relative to each other and traverse the distance of the main body 12, i.e. run from the first end 22 to the second end 24. Alternatively, the fins 50 may be arranged in a discontinuous manner, having a fin which extends a predetermined distance, followed by a predetermined distance with no fin structure. The alternating pattern of fin structure/no fin structure can be repeated along the length of the main body 12. Accordingly the heat exchanging fin 50A is aligned in a substantially parallel manner with the heat exchanging fin 50B. Such arrangement provides for the formation of one or more fluid channels 52. Each of the fins 50 has a length that traverses the length of the main body, running from the first end 22 to the second end 24. The height of each fin extends from the inner surface 46 of the bottom wall 16 to the inner surface of the top wall 14 (not illustrated). The positioning of each of the fins 50, as well as the physical characteristics, i.e. the height and length, provide individual channels for directional flow of fluid within the main body 12 of the heat exchanger 10, and act as a thermally conductive path. Each of the channels 52 formed are defined by the space between at least one fin and 1) a second fin, 2) the proximal wall, or 3) the distal wall. Additionally, the fins 50 provide a thermally conductive path to the heat exchanger main body 12. These elements promote controlled fluid flow and serve to prevent dead spots or undesirable circulating eddies.

While providing flow distribution with the heat exchanger in this manner reduces the likelihood of excess and insufficient flow zones, one problem not addressed is the flow rate and/or flow distribution of fluids prior to reaching the channels 52. To overcome such problems, the heat exchanger with flow directors 10 in accordance with the present invention utilizes one or more flow directors 54 positioned within or extending into the inlet manifold 26, the outlet manifold 34, or combinations thereof. The embodiment of the heat exchanger with flow directors 10 illustrated in FIG. 4A shows flow directors (individually as 54A, 54B, 54C, and 54D) formed as part of or positioned on the interior surface 58 of the interior 60 of the inlet manifold 26. In this manner, directional flow of fluid entering into the heat exchanger with flow directors 10 can be directed to one or more of the fluid flow channels 52. Referring to FIG. 4B, fluid entering into the opening 28 of the inlet manifold 26 is directionally diverted into particular flow channels 52.

To achieve the directional diversion of fluid, the flow directors 54 are adapted and positioned to direct the fluid flow accordingly. As fluid is introduced into the inlet manifold 26, see arrow 61 on FIG. 4B, the fluid flow path 62 in the inlet manifold 26 is initially and predominantly in the direction of the longitudinal axis 64 (see FIG. 1) of the inlet manifold 26. At least one of the flow directors 54 is employed to urge the fluid from this path and into heat exchanging body 12.

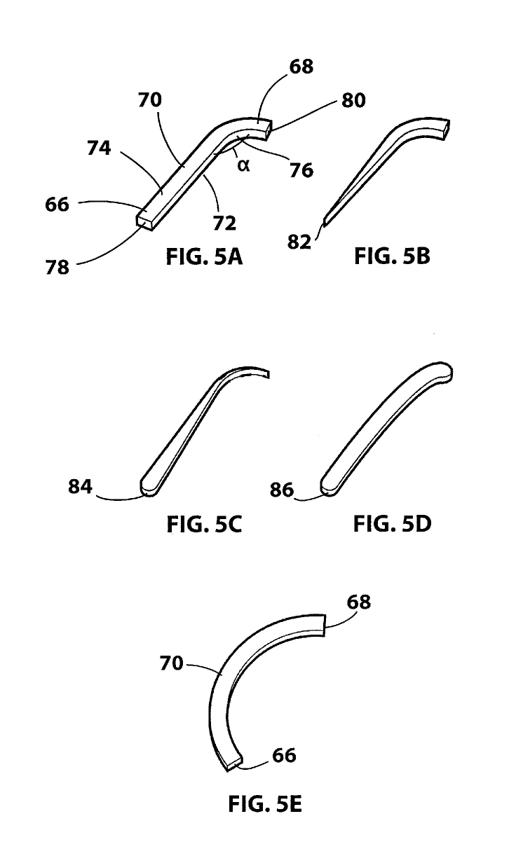

Referring to FIG. 5A, as an illustrative example, the flow directors 54 have a first end 66 positioned to align with one end of a heat exchanger fin 50, a second end 68 aligned with the fluid flow path 62 of the inlet manifold 26, and a flow director body 70. The flow director body 70 has an inner surface 72 for contacting and diverting fluid into a channel 52 and a second outer surface 74 for contacting and diverting fluid flow along the longitudinal axis 64 (see FIG. 1) of the inlet manifold 26. As shown in FIGS. 4A and 4B, the flow director body 70 is arranged in a generally parallel arrangement to the longitudinal axis 64 and spaced apart from other flow director bodies 70. This arrangement allows each flow director 54A-54D to be arranged in a step-like fashion along the interior surface 60 of the inlet manifold 26, each being parallel to the preceding flow director 54. Alternatively, the flow directors 54 can be arranged to have a more diagonal orientation. Preferably, the flow directors 54 have a curved surface 76 to provide gradual and efficient re-direction of fluid flow direction so that fluid entering the heat-exchanging element becomes aligned with the flow channels 50, thereby minimizing hydrodynamic pressure losses.

The degree of curvature may vary depending on the type of fluid flow and other characteristics needed with respect to the exchange of heat per application. For example, the curvature may form an angle α between greater than 0 degrees and less than 180 degrees, preferably approximately 90 degrees. Without these flow directors, the fluid in the fluid manifold 15 tends to continue in a straight path parallel to the longitudinal axis of the fluid manifold until the fluid reacts with the distal wall 44. This reaction generates a great deal of turbulence, resulting in hydraulic inefficiency. Further, the fluid flow is now such that a disproportionate volume of fluid flows into the fluid channel nearest the distal wall 44. This disproportionate flow results in uneven heat transfer and potential hot spots in the heat exchanger, and similarly the device to be cooled or heated. A further advantage of the application of the flow directors is in the reduction of mechanical wear on the heat exchanger and the fluid manifold. Such wear is aggravated by turbulent flow, cavitation and high-pressure fluid impact on the components of the system. The present design serves to minimize these negative effects.

Each flow director 54 may be preformed as a single unit, sized to have a predetermined height. Alternatively, each flow director 54 may be formed by multiple stacked, laminar flow director elements or platelets secured together to form an overall three dimensional shape. Referring to FIGS. 4A-4C, flow director 54 are made of a plurality of laminar flow director elements or platelets. As an illustrative example, the flow director 54C is made up of two flow director laminar elements or platelets 54C′ and 54C″. While the Figure illustrates two flow director laminar elements or platelets, any number may can be used to make the structure. The multiple stacked, laminar elements or platelets 54C′ and 54C″ can be assembled by brazing or other suitable means and may be produced simultaneously with the formation of the inlet manifold 26, as will be described later. Each of the other flow directors 54A-54D are constructed in the same manner. To aid in the alignment and construction, each of the flow director 54 are secured by support structures, illustrated herein as stringer 55, see FIG. 4C. All or portions of the stringer 55 may be removed to form the final configuration in order to allow proper fluid flow. Otherwise, the strangers 55 are configured to provide optimal fluid flow. The net shape of the flow directors 54, therefore, can be easily and precisely controlled by defining the shape of the individual laminar elements or platelets from which they are comprised. Individual platelet formation is usually accomplished by photochemical machining, fine blanking, laser or water jet cutting or other known processes.

While the shape of the flow directors 54 illustrated shows a square leading edge 78 at the first end 66 and a trailing edge 80 at the second end 68, the leading and trailing edges and indeed the entire director can take any form desired which provides one fluid flow directional change, such as but not limited to a wedge 82, see FIG. 5B, teardrop 84, see FIG. 5C, a complex curve 86, see FIG. 5D. In this example, the form of the directors is readily controlled by defining the shape of the platelets from which it is comprised. Additionally, the overall shape of the flow directors 54 may have a generally “C” shape, see FIG. 5E. In any configuration, the flow directors 54 are preferably configured to provide a directional fluid flow change with respect to the original fluid flow path entering, exiting, or combinations thereof, the heat exchanging device with flow directors 10.

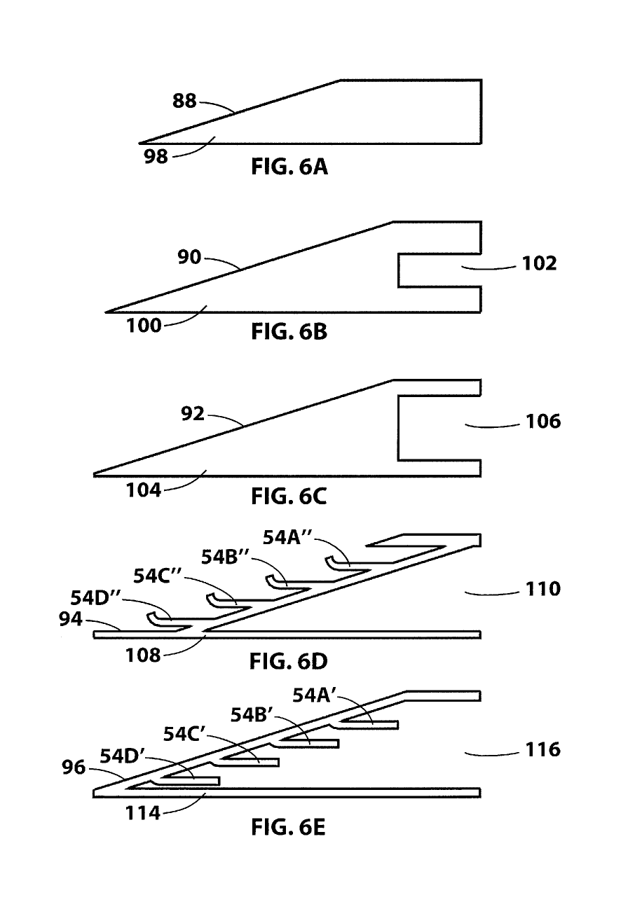

The manifold inlet 26 illustrated in FIGS. 4A, 4B and 4C is constructed of multiple, stacked manifold laminar plates 88, 90, 92, 94, and 96 that, when combined, produce the desired net overall shape, for example a generally cylindrical shape. The plates 88-96 may have individual features that contribute to the overall shape and functional features of the inlet manifold 26. For example, the manifold laminar plate 88 may be constructed to contain a single solid, planar surface 98 having no surface configurations, see FIG. 6A. The manifold laminar plate 90 may contain a planar surface 100 having a cut-out portion 102. See FIG. 6B. The manifold laminar plate 92 may contain a planar surface 104 having a cut-out portion 106, see FIG. 6C, that is wider than the cut out portion 102.

The manifold laminar plate 94 may contain a planar surface 108 having a cut-out portion 110 that is wider than the cut out portion 106. The manifold laminar plate 94 contains one or more flow director laminar elements or platelets 54A″, 54B″, 54C″, and 54D″. The flow director laminar elements or platelets 54A″, 54B″, 54C″, and 54D″ are preferably formed as an integral part of the plate 94, but may be formed independently and attached thereto. The manifold laminar plate 96 may contain a planar surface 114 having a cut-out portion 116 that is wider than the cut out portion 110. Additionally, the planar surface 114 may contain one or more flow director laminar elements or platelets 54A′, 54B′, 54C′, and 54D′. The flow director laminar elements or platelets 54A′, 54B′, 54C′, and 54D′ are preferably integrally formed with the plate 94, but may be formed independently and attached thereto.

Alignment or positioning of the flow director laminar elements or platelets 54A′, 54B′, 54C′, and 54D′ allows for alignment with and proper positioning with respect to the flow director laminar elements or platelets 54A″, 54B″, 54C″, and 54D″ so as to provide a stacked unit which forms the flow directors 54. This configuration allows for the flow directors 54 to form three dimensional structures having a desired shape. Accordingly, placing manifold laminar plate 96 on top of the manifold laminar plate 94 forms a plurality of stacked, laminar elements or platelets to form the flow directors 54. As shown in FIGS. 4A and 4B, the cut out portions create a stepped region at the opening 28, formed by each successive manifold laminar plate forming a cantilevered area 120 relative to the preceding plate. The upper portion of the inlet manifold 26 may be formed as a mirror image of the lower portion just described.

The multiple, stacked manifold laminar plates 88, 90, 92, 94, and 96 may be bonded, joined or otherwise affixed to one another by a variety of processes. A suitable method to bond the manifold laminar plates is by soldering, brazing or diffusion bonding. If soldering or brazing is to be employed, the soldering or brazing alloy may be applied to one or both of the faces to be bonded. Further, the soldering or brazing alloy may be in the form of cladding or a plated layer on the laminar material, which when heated, bonds the adjacent layers. Brazing may also be accomplished by “dip-brazing” or other suitable processes as long as the process does not significantly interfere with desirable fluid path geometries. In lieu of or in addition to bonding adjacent layers by diffusion bonding or brazing, any suitable welding process may be employed to bond adjacent layers without the use of a brazing alloy. While the multiple, stacked manifold laminar plates 88, 90, 92, 94, and 96 are shown as independent plates bonded together, the stacked manifold laminar plates may be designed as a single strip so that each one of the stacked manifold laminar plates can be folded onto the next plate. Alternately, successive layers of the manifold laminar plates may be joined at their periphery by soldering, brazing or welding. Welding processes may include, but are not limited to, laser welding, electron-beam welding, ultrasonic welding, resistance welding, press welding, any of the processes referred to as “arc-welding,” GMAW, MIG, TIG or the like.

The above laminar element bonding or welding processes assume that the heat exchanger element is comprised of metal or a metal alloy. The structure could however be comprised, without being limiting, of other materials such as ceramics, polymers, glasses or composites. Adhesives such as epoxies, cyanoacrylates, silicones or other materials may be employed to bond adjacent layers and/or seal the periphery of the heat exchanger element instead of or in addition to brazing and/or welding.

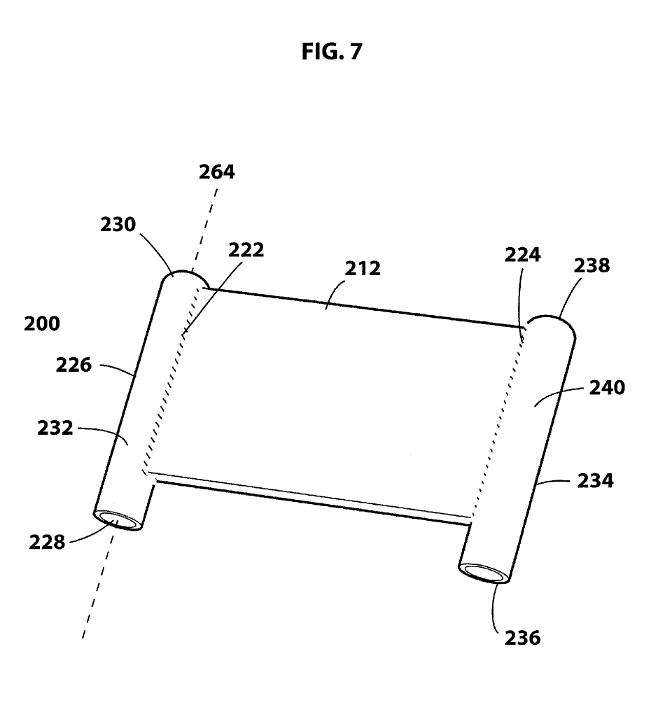

FIG. 7 illustrates an alternative embodiment of the heat exchanging device with flow directors generally referred to as 200. The heat exchanging device with flow directors 200 contains a main body 212, preferably made of a laminar material and/or other materials that exchange heat including aluminum copper, nickel, brass or stainless steel, ceramics, plastics, glass, or other suitable materials which acts as a heat exchanging element. The main body 212 may be formed by an extrusion process, though other methods known to one of skill in the art may also be employed. The main body 212 is defined by a plurality of walls as described for the heat exchanging device with flow directors 10 and having a first end 222 and a second end 224.

The first end 222 of the main body 212 contains a substantially cylindrically shaped first manifold, an inlet manifold 226, integrally formed or attached thereto. The manifold 226 contains a first open end 228 sized and shaped to allow fluids, such as a liquid or a gas, to enter therein, a second closed end 230, and a manifold body 232 there between. The second end 224 of the main body 212 may be open to allow fluid that has entered into and flowed within the main body 212 to exit. The inlet manifold 226 is provided to facilitate coupling of fluid inlet lines, such as hoses, tubes or pipes, or other conduits to the heat exchanger. While the inlet manifold 226 is shown having a generally cylindrical shape, any shape may be used.

Alternatively, the heat exchanging device with flow directors 200 contains a second manifold, an outlet manifold 234, integrally formed or attached to the second end 224. The outlet manifold 234 as shown contains a first end 236 which is open and sized and shaped to allow fluids, such as a liquid or a gas, to exit, a second end 238 which is closed, and an outlet manifold body 240. While the outlet manifold 234 is shown having the first end 236 being open, it is within the scope of this invention that the second end 238, or both ends 236 and 238 contain an opening for fluid flow. The outlet manifold 234 is provided to facilitate coupling of fluid outlet lines, such as hoses, tubes or pipes, or other conduits to the heat exchanger. While the outlet manifold 234 is shown having a generally cylindrical shape, any shape may be used.

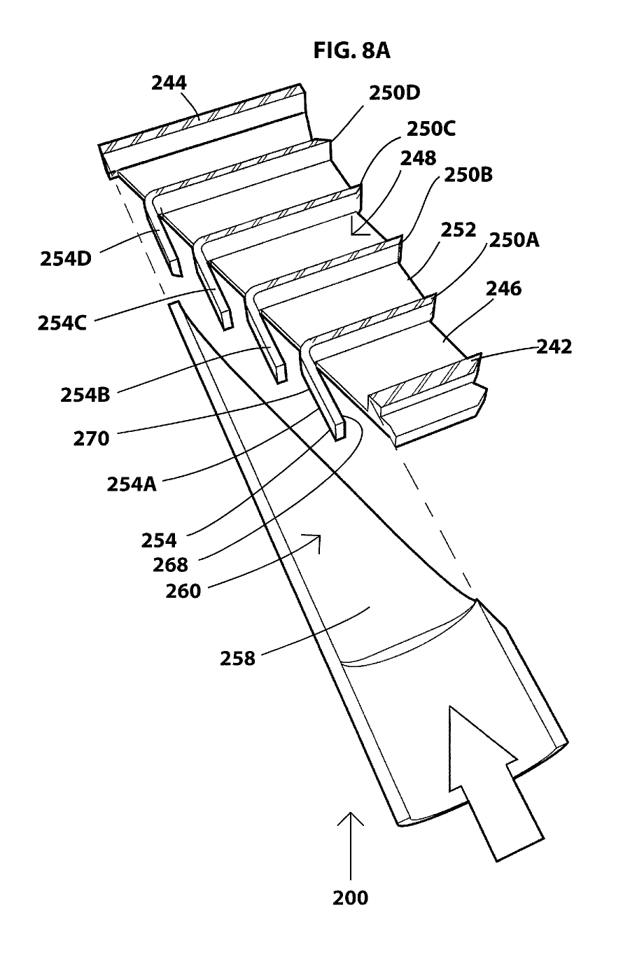

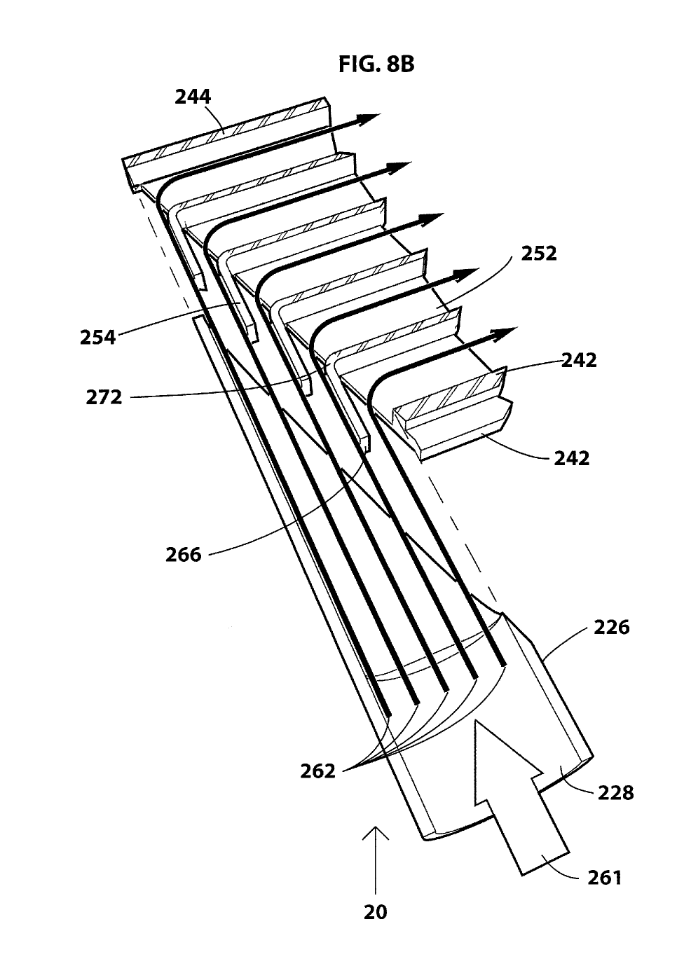

Referring to FIG. 8A, the upper wall has been removed in order to illustrate the inner components and arrangement thereof. In addition, the outlet manifold 234 has been removed. The main body 212 is adapted to provide fluid containment, having a first proximal wall 242 and a second distal wall 244. Both the first proximal wall 242 and the second distal wall 244 traverse the length of the heat exchanging device with flow directors 200 and have a height which extends from the inner surface 246 of bottom wall to the inner surface of top wall (not illustrated). The first proximal wall 242 and the second distal wall 244 function to contain and confine a heat exchanging fluid, such as a liquid or a gas, to the interior 248 of the heat exchanging device with flow directors 200.

Placed within the interior 248 are one or more heat exchanging elements, illustrated herein as heat exchanging fins 250A-250D, collectively referred to as heat exchanging fins 250. The fins 250 are preferably made of metal having heat conductive properties such as aluminum or copper. The fins are preferably formed during the aforementioned extrusion process. The fins 250 are arranged in a substantially parallel manner relative to each other and traverse the distance of the main body 212, i.e. run from the first end 222 to the second end 224, or may be discontinuous. Accordingly, the heat exchanging fin 250A is aligned in a substantially parallel manner with the heat exchanger fin 250B. Such arrangement provides for the formation of one or more fluid channels 252.

Each of the fins 250 has a length that traverses the length of the main body, running from the first end 222 to the second end 224. The height of each fin extends from the inner surface 246 of the bottom wall to the inner surface of the top wall. The positioning of each of the fins 250, as well as the physical characteristics, i.e. the height and length, provides individual channels for directional flow of fluid within the main body 212 of the heat exchanger 200, and act as a thermally conductive path. Additionally, the fins 250 provide a thermally conductive path to the heat exchanger main body 212. These elements promote controlled fluid flow and serve to prevent dead spots or undesirable circulating eddies. Alternatively, the fins 250 may be arranged in a discontinuous manner, having a fin which extends a predetermined distance, followed a predetermined distance with no fin structure. The alternating pattern of fin structure-no fin structure can be repeated along the length of the main body 212.

While providing flow distribution with the heat exchanger in this manner reduces the likelihood of excess and insufficient flow zones, one problem not addressed is the flow rate and/or flow distribution of fluids prior to reaching the channels 252. To overcome such problems, the heat exchanger with flow directors 200 in accordance with the present invention utilizes one or more flow directors 254 integrally formed as part of fins 250 and extending into the inlet manifold 226, the outlet manifold 234, or combinations thereof.

The embodiment of the heat exchanger with flow directors 200 illustrated in FIG. 8A shows flow directors 254 (individually as 254A, 254B, 254C, and 254D) preferably, but need not (i.e. can be free floating), contact the interior surface 258 by extending into the interior 260 of the inlet manifold 226. The flow directors 254 assume a bent finger configuration. In this manner, directional flow of fluid entering into the heat exchanger with flow directors 200 can be directed to one or more of the fluid flow channels 252. Referring to FIG. 8B, fluid entering into the opening 228 of the inlet manifold 226 is directionally diverted into particular flow channels 252.

To achieve the directional diversion of fluid, the flow directors 254 are adapted and positioned to direct the fluid flow accordingly. As fluid flows into the inlet manifold 226, see arrow 261 on FIG. 8B, the fluid flow path 262 in the inlet manifold 226 is initially and predominantly in the direction of the longitudinal axis 264 of the inlet manifold 226, see FIG. 7. At least one of the flow directors 254 is employed to urge the fluid from this path and into the main body 212.

As an illustrative example, the flow directors 254 have a terminal end 266 which extends into the inlet manifold 226. The flow director 254 has a first surface 268 for contacting and diverting fluid into a channel 252 and a second surface 270 for contacting and diverting fluid flow along the longitudinal axis 264 of the inlet manifold 226. As shown in FIGS. 8A and 8B, each flow director 254A-254D assumes a position which is offset and is in a parallel arrangement relative to the positioning of a flow director above or below. This arrangement allows each flow director 254A-254D to be arranged in a step-like fashion along the interior 260 of inlet manifold 226. Alternatively, the flow directors 254 can be arranged to have a more diagonal orientation. Preferably, the flow directors 254 have a curved surface 272 to provide gradual and efficient re-direction of the fluid flow direction so that flow entering the heat-exchanging element becomes aligned with the flow channels 252 thereby minimizing hydrodynamic pressure losses.

The degree of curvature may vary depending on the type of fluid flow and other characteristics needed with respect to the exchange of heat per application. For example, the curvature may form an angle α that is between greater than 0 degrees and less than 180 degrees, and preferably around 90 degrees. Without these flow directors, the fluid in the fluid manifold 226 tends to continue in a straight path parallel to the longitudinal axis of the fluid manifold until the fluid reacts with the distal wall 244. This reaction generates a great deal of turbulence, resulting in hydraulic inefficiency. Further, the fluid flow is now such that a disproportionate volume of fluid flows into the fluid channel nearest the distal wall 244. This disproportionate flow results in uneven heat transfer and potential hot spots in the heat exchanger, and similarly the device to be cooled or heated. A further advantage of the application of the flow directors is in the reduction of mechanical wear on the heat exchanger and the fluid manifold. Such wear is aggravated by turbulent flow, cavitation and high-pressure fluid impact on the components of the system. The present design serves to minimize these negative effects.

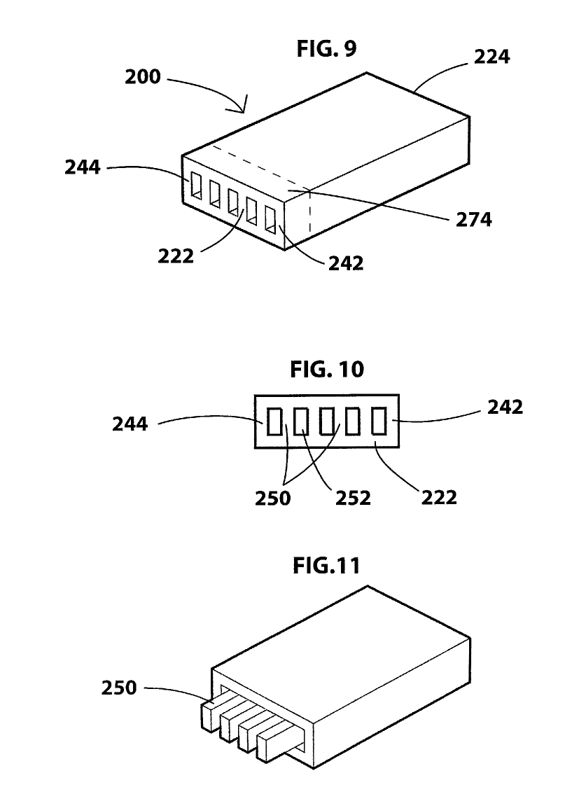

Referring to FIGS. 9-11, an illustrative example of formation of the bent finger like flow directors 254 is shown. FIG. 9 illustrates the heat exchanger with flow directors 200 formed through an extrusion process. The inlet manifold 226 has not been attached, thereby exposing the first end 222. Through the extrusion process, multiple channels 252 are formed, bounded by heat exchanging fins 250. The flow directors 254 may be formed by removing, for example by sawing or milling after the extrusion process, a portion of the front, back and side walls that make up the heat exchanger main body 212, as well as the first proximal wall 242 and the second distal wall 244, see broken line 274 in FIG. 9, thereby exposing an overhang as part of the heat exchanging fins 250, see FIG. 11. The overhang portion is then formed into the flow directors 254. In the case of an extruded heat-exchanging element, the flow directors 254 may simply be extensions of the laminar flow elements, i.e. the heat exchanging fins 250 that are formed during the extrusion process. While the extrusion process is efficient and permits complex extrusion profiles to be formed through the use of an appropriate die, the process has its limitations. For example, the shape of an extruded part can essentially only be controlled in 2½ dimensions. That is, the part must have a constant shape profile throughout its length. And while the length can be specified, the profile along that length must remain constant.

If the desired flow directors 254 are to be created from extensions of the extrusion profile, then their curved shape must be formed after the extrusion process. Bending these flow directors 254 may be accomplished either manually, with an automated bender or by application of a special tool. A convenient means of bending to form flow directors 254 is to employ an open topped tool with a plurality of substantially parallel curved channels. Forcing the flow directors 254 into the channels causes the flow directors 254 to bend to fit the curves. If plastically deformed, the flow directors 254 will remain curved and take on the shape desired for the flow directors. The open topped tool permits the heat exchanging element, and the now curved flow directors 254 to be lifted out of the tool.

While the above embodiments have been described showing an inlet manifold 28, 228, each embodiment may include an outlet manifold 34, 234 having the flow directors as having the same features and characteristics described herein. In addition, the outlet manifold 34 or 234 may contain flow directors arranged to direct outward fluid flow toward end 36 or 236 thereby providing for U-shaped fluid flow, or directed to end 238 to provide for Z-shaped fluid flow.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A heat exchanging device which reduces fluid turbulence thereby reducing hydraulic inefficiency comprising:
a main body adapted for heat exchange having a plurality of channels adapted to receive fluid flow, said main body having a first wall and a back wall sized and shaped to contain fluid flow therein;
a plurality of heat exchanging elements positioned between said front wall and said back wall to form at least one fluid flow channel, each said heat exchanging element having a length that traverses the length of said main body;
at least one flow director adapted for directing fluid flow; and
at least one fluid manifold adapted for receiving fluid from an external source;
said fluid from an external source being directed to said fluid flow channels whereby hydraulic efficiency is maximized by preventing fluid turbulence associated with non-directed flow of fluid within.

2. The heat exchanging device according to claim 1 wherein said heat exchanging elements are heat exchanging fin structures.

3. The heat exchanging device according to claim 1 wherein said channels are defined by the space between one heat exchanging element and a second heat exchanging element, said front wall, or said back wall.

4. The heat exchanging device according to claim 1 wherein said manifold is an inlet manifold, an outlet manifold, or combinations thereof.

5. The heat exchanging device according to claim 1 wherein said flow directors are positioned along the inner surface of said fluid flow manifold.

6. The heat exchanging device according to claim 1 wherein said flow directors are adapted to re-direct the direction of fluid entering said main body thereby minimizing hydrodynamic pressure loss.

7. The heat exchanging device according to claim 6 wherein said flow directors are adapted to redirect inlet fluid flow along the longitudinal axis of said manifold at an angular direction.

8. The heat exchanging device according to claim 6 wherein said flow directors are shaped to direct fluid flow from said manifold to said at least one channel.

9. The heat exchanging device according to claim 1 wherein said flow detectors are made from two or more laminar platelets.

10. The heat exchanging device according to claim 9 wherein said laminar platelets are secured together to form a three dimensional shape.

11. The heat exchanging device according to claim 1 wherein said flow detectors are integrally formed from said inlet manifold.

12. The heat exchanging device according to claim 1 wherein said flow detectors are integrally formed from said plurality of heat exchanging elements.

13. The heat exchanging device according to claim 1 wherein said flow directors act to reduce the amount of fluid flow into the fluid channel formed by the distal wall and said heat exchanger element.

14. The heat exchanging device according to claim 1 wherein said fluid flow manifold contains a plurality of manifold laminar plates, said plurality of manifold laminar plates secured together to form a predetermined shape.

15. The heat exchanging device according to claim 14 wherein said at least one manifold laminar flow element contains a fluid flow director laminar platelet.

16. The heat exchanging device according to claim 15 wherein at least two manifold laminar flow elements contain fluid flow director laminar platelets, said at least two manifold laminar flow elements being stacked so that said fluid flow director laminar platelets align to form a predetermined three dimensional shape.

17. A method of forming a heat exchanging device having fluid flow directors which reduce fluid turbulence thereby reducing hydraulic inefficiency comprising the steps of:
providing a heat exchanger having a plurality of channels adapted to receive fluid flow and a plurality of heat exchanging elements;
providing at least one flow director adapted for directing fluid flow, said at least one fluid flow director being fluidly aligned with at least one of said plurality of channels adapted for fluid flow;
providing at least one fluid manifold adapted for fluid flow therein, said at least one fluid flow manifold formed from a plurality of manifold laminar elements.

18. The method of forming a heat exchanging device having fluid flow directors which reduce fluid turbulence thereby reducing hydraulic inefficiency according to claim 17 wherein at least one said laminar element comprises a fluid flow director.

19. The method of forming a heat exchanging device having fluid flow directors which reduce fluid turbulence thereby reducing hydraulic inefficiency according to claim 17 wherein said heat exchanger is formed by an extrusion process.

20. The method of forming a heat exchanging device having fluid flow directors which reduce fluid turbulence thereby reducing hydraulic inefficiency according to claim 17 wherein said fluid flow directors are located within said at least one fluid manifold.

21. The method of forming a heat exchanging device having fluid flow directors which reduce fluid turbulence thereby reducing hydraulic inefficiency according to claim 20 wherein said fluid flow directors are adapted to re-direct the direction of fluid flow entering said main body thereby minimizing hydrodynamic pressure loss.

22. The method of forming a heat exchanging device having fluid flow directors which reduces fluid turbulence thereby reducing hydraulic inefficiency according to claim 21 wherein said flow directors are adapted to provide fluid flow at an angle from a longitudinal axis of said at least one manifold.

23. The method of forming a heat exchanging device having fluid flow directors which reduces fluid turbulence thereby reducing hydraulic inefficiency according to claim 17 wherein said at least one fluid flow manifold is formed concurrently with forming said fluid flow directors.

24. A method of forming a heat exchanging device having fluid flow directors which reduce fluid turbulence thereby reducing hydraulic inefficiency comprising the steps of:
providing a heat exchanger having a plurality of channels adapted to receive fluid flow and a plurality of heat exchanging elements;
forming at least one flow director adapted for directing fluid flow to a predetermined shape, said at least one fluid flow director being fluidly aligned with at least one of said plurality of channels adapted for fluid flow,
said formation of said at least one fluid flow director including the steps of removing a portion of said heat exchanger, exposing said plurality of heat exchanging elements, and forming at least one flow director by shaping said exposed plurality of heat exchanging elements to a predetermined shape;
providing at least one fluid manifold adapted for fluid flow therein; and
securing said at least one fluid flow manifold to said providing a heat exchanger.

25. The method of forming a heat exchanging device having fluid flow directors which reduce fluid turbulence thereby reducing hydraulic inefficiency according to claim 24 wherein said heat exchanger is formed by an extrusion process.

26. The method of forming a heat exchanging device having fluid flow directors which reduce fluid turbulence thereby reducing hydraulic inefficiency according to claim 24 wherein said flow directors are integrally formed from said plurality of heat exchanging elements.

27. The method of forming a heat exchanging device having fluid flow directors which reduce fluid turbulence thereby reducing hydraulic inefficiency according to claim 24 wherein said flow directors extend into said at least one fluid flow manifold.

28. The method of forming a heat exchanging device having fluid flow directors which reduce fluid turbulence thereby reducing hydraulic inefficiency according to claim 26 wherein said predetermined shape includes a curvature for directing fluid flow into said channels.

29. The method of forming a heat exchanging device having fluid flow directors which reduces fluid turbulence thereby reducing hydraulic inefficiency according to claim 24 wherein said flow directors are adapted to provide fluid flow at an angle from a longitudinal axis of said at least one manifold.
